(19) United States
(12) Patent Application Publication
(10) Pub. No.: US 2007/0168088 A1
(43) Pub. Date: Jul. 19, 2007

(54) POWER DISTRIBUTION LOAD SHEDDING SYSTEM AND METHOD OF USE

(75) Inventors: Carrel W. Ewing, Reno, NV (US); Jay H. Williams, Yankton, SD (US); Brandon W. Ewing, Reno, NY (US); Brian P. Auclair, Reno, NY (US)

Correspondence Address: KLARQUIST SPARKMAN, LLP, 121 SW SALMON STREET, SUITE 1600, PORTLAND, OR, 97204, US

(73) Assignee: Server Technology, Inc.

(21) Appl. No.: 11/556,151

(22) Filed: Nov. 2, 2006

Related U.S. Application Data
(60) Provisional application No. 60/733,327, filed on Nov. 2, 2005.
(60) Provisional application No. 60/851,376, filed on Oct. 13, 2006.

(51) Int. Cl. G05D 11/00

(52) U.S. Cl. 700/295

(57) ABSTRACT

A method of power administration includes monitoring at least one of a plurality of operating conditions relating to a plurality of outlets within a power distribution unit, determining whether a pre-determined operating condition threshold has been met, and, if the pre-determined threshold has been mete powering off less than all of the power outlets within the power distribution unit.

### CROSS-REFERENCE TO RELATED APPLICATION

This application claims the benefit of U.S. Provisional Application No. 60/733,327, filed Nov. 2, 2005, entitled UPS LOAD SHEDDING APPARATUS & METHOD, and U.S. Provisional Application No. 60/851,376, filed Oct. 13, 2006, entitled UPS LOAD SHEDDING APPARATUS & METHOD, the contents of both of which are hereby incorporated herein by reference,

### FIELD

The disclosed technology relates to systems and methods for power administration and, more specifically, to powering off outlets within a power distribution unit based on operating or other conditions.

### BACKGROUND

The industrialized and many other nations of the world have long depended on electricity. For example, the widespread use of computer technology has made it essential that virtually all businesses have uninterrupted electrical power in order to conduct their business.

Utility companies have long been fairly reliable in providing power. Nevertheless, unforeseen events such as inclement weather, excessive demand, or accidents often interrupt the power supplied by utility companies. A utility company may even intentionally implement a rolling blackout—losses of power to multiple geographic areas in series over time—when demand exceeds capability.

Because of the possibility of power outages, many businesses and other entities use battery backup systems to ensure that electrical power will be available for critical items even if a utility outage occurs. One technology that has developed to avoid power outages is the Uninterruptible Power Supplies (UPS). A UPS typically includes a battery providing reserve electrical power if a main source of electrical power fails. Thus, if utility power fails, electric services can continue as long as the UPS device provides sufficient battery power to supply the needed electricity One type of application in which U:PS systems have long been used to provide back-up power is in places having computing, networking, and/or other telecommunications devices. In these applications, computers, network routers, servers satellite receives, and/or other electronic appliances are typically mounted in vertical or other racks. The appliances commonly are each housed in rack-mountable chassis in order to mount the appliances in the rack(s). These electronic appliance chassis are typically vertically sized in standard sized vertical units (U). Thus, an appliance that has a 1U high housing consumes 1 standard unit of vertical appliance mounting space in a rack. Since each rack has only so much front-side vertical rack mounting space (i.e., rack space in the front of the rack or rack cabinet), network and other rack users, such as a telecommunications network or data center operator, commonly seek to reserve front-side vertical rack mounting space for communications, computing, and other equipment to which frontal access is required or for which mounting in the standard vertical unit mounting area is otherwise required or desired due to, for example, the configuration of the housing for a device.

In a rack environment also having backup battery power such as via a UPS, two kinds of operating power often can be supplied to the electronic appliances in the rack: alternating current (AC) from, e.g., the uninterruptible power supply (UPS) or direct from a utility; and direct current (DC) from, e.g., central office battery sets. Prior art devices have been marketed that control and distribute such AC or DC power to these network appliances.

For example, Server Technology, Inc., or Reno, Nevada, provides remotely controllable operating-power-distribution equipment or units (PDUS) such as for use in racks, including RETMA racks. Commonly, a PDU has a vertical and relatively narrow form factor so that it can be mounted in a rack to distribute power vertically along the rear or power input side of the appliances mounted vertically in the standard unit or similar space in the rack. Sometimes, however, the PDU may have a differing form factor, such as a horizontal form factor, for mounting otherwise in the rack, such as in the standard unit mounting space or other horizontal location.

One common type of PDU system has long had the ability to not only distribute power from a power input such as from a UPS or direct from a power utility to each of the appliances in the rack but also to, for example, monitor the ambient temperature of the PDU and cycle operating power on and off to individual network appliances to which the PDU supplies power. Such cycling of operating power typically forces a power-on/off reset of the network appliance. This power cycling is sometimes needed when an appliance locks up or bombs. Since the network appliance is usually located remote from the network administration center, these types of PDUs have been helpful in remotely monitoring and controlling network-appliance operating power over the Internet and other communications networks.

When, however, the supply of power to a PDU terminates, such as via loss of both utility supplied and reserve battery power from a UPS, all appliances that are supplied power by the PDU typically lose all power supplied to them. This can force an undesired, and sometimes quite costly and even dangerous, shut down of all appliances supported by the PDU simultaneously or nearly simultaneously in the rack or other environment in which a UPS-supported PDU supplies power to one or more appliances.

### SUMMARY

The disclosed technology provides an uninterruptible or other reserve or backup power supply (collectively “reserve power supply”) in power supply communication with a power distribution system. The power distribution system has a power input and plurality of power outlets for connection to external electrical devices. The technology includes load shedding capability that monitors the main or reserve power supply, power provided by such a power supply, or information about such a power supply and then, as a result of one or more conditions determined by such monitoring, can shed or turn off power to all or less than all power outlets on the power distribution unit.

In certain embodiments, the load shedding capability may include the ability to power down each among a series of subsets of predetermined outlets over a period of time.

In certain embodiments, this load shedding capability may terminate when and if the power or monitoring indicates that one or more conditions warrant such termination.

In some embodiments, the load shedding capability may operate in reverse, causing power outlets to be powered back on when a condition returns to desired state. In certain embodiments, the reverse operation may commence when the reserve power supply resumes the ability to provide power from an outside source, such as a power input to the reserve power supply.

In certain embodiments, the power distribution unit or the reserve power supply, or both, are connected to a communications network and exchange power monitoring information and or power controlling information with a remote system over the network. In certain embodiments, the power distribution unit and reserve power supply may be integrated.

The disclosed technology can provide the capability of monitoring multiple different UPS, reserve, or backup devices to ensure that power is available and, when power interruptions occur, automatically conserve or reserve the remaining power by shedding load from one or more predetermined devices.

In some embodiments, the disclosed technology also can signal a remote shutdown agent on the attached device to cause an orderly shutdown of the attached device before power is terminated for the device.

In some embodiments, the disclosed technology can first check a supported device to ensure that it is the desired device before causing the power supplied to the device to terminate.

In some embodiments, the power distribution system may provide environmental monitoring such as monitoring of temperature, humidity, smoke, or water, for example. In certain embodiments, the power distribution system may include the capability of shutting down power from one or more components of the system depending on the level of the environmental condition monitored. In some embodiments, the power distribution system may also provide controlled load shedding in such events if desired.

In one embodiment, the power distribution unit includes one or more housings, with one or more such housings including one or more power distribution outlets. One or more such housings may have a vertical form factor and be mounted in various locations in or supporting an associated electrical equipment rack. A given housing may also have a horizontal or other form factor.

In one embodiment, one or more reserve power supplies may be implemented in conjunction with one or more separate power distribution units or housings. A reserve power supply may have a vertical or horizontal form factor and, depending on the form factor, may be mounted in various locations in or to support a given rack or other arrangement of associated appliances.

The foregoing is a brief summary of various aspects of embodiments of the disclosed apparatus and method of use. There are additional aspects that will become apparent as this specification proceeds.

In this regard it is to be understood that a given, embodiment of the present invention need not provide or include all such aspects nor address all or any of the issues with the prior art noted in the background above Rather, the scope of the present invention is to be determined by the claims as issued.

### BRIEF DESCRIPTION OF THE DRAWINGS

Various embodiments are shown and described in association with the accompanying drawings in which:

FIG. 1 is a schematic view of the general architecture of an implementation of a network power administration system with load shedding functionality

FIG. 2 is a flowchart of the general logic of a load shedding thread for the system of FIG. 1.

FIG. 3 is a flowchart of the logic of a sample UPS load shedding operation for the system of FIG. 1.

FIG. 4 is a flowchart of the logic of a sample temperature load shedding operation for the system of FIG. 1.

FIG. 5 is a flowchart of the logic of a sample infeed load load shedding operation for the system of FIG. 1.

FIG. 6 is a flowchart of the logic of a load shedding thread used to signal a remote shutdown agent for the system of FIG. 1.

FIG. 7 is a three-dimensional view of an embodiment of the disclosed technology utilizing one or more PDUs powered by a separate UPS mounted in a RETMA rack.

FIG. 8 is a schematic view of an alternative embodiment of the disclosed technology, including a master PDU and a slave PDU.

### DETAILED DESCRIPTION OF EMBODIMENTS

### Network Power Administration System

A network power administration system can provide data, networking, or telecommunication center managers with the ability to monitor and manage equipment in associated data, telecommunication, or networking centers. Such a system can provide a variety of features such as, for example, intelligent power distribution, remote management (e.g., to power equipment on and off), input current power monitoring, environmental monitoring of temperature, humidity, water sensing, smoke, and/or contact closures.

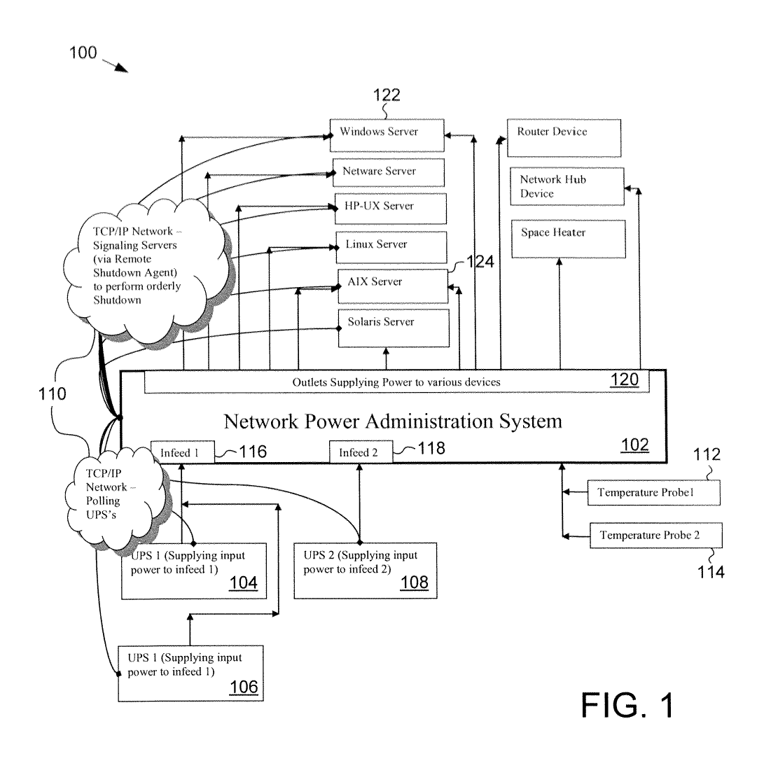

FIG. 1 is a schematic view showing the general architecture 100 of an implementation of a network power administration system 102. In the illustrated embodiment, multiple power supply devices (e.g., uninterruptible power supplies or UPSes 104 and 106) can supply power to a single infeed (e.g., 116), and a single server can be powered by multiple power supplies so that more than one network power administration system outlet may be supplying power to a single server. For example, in the illustrated embodiment, the Windows Server 122 and the AIX Server 124 have multiple power sources. In various embodiments, the power supply devices can be one of or a combination of the following: reserve power supplies, backup power supplies, and uninterruptible power supplies, for example.

The network power administration system 102 can monitor the status of the UPSes' 104-108 external power using the TCP/IP network 110. The network power administration system 102 can also monitor temperature readings from the two temperature probes 112-114 and can also monitor the power load being consumed by the two infeeds 116-118. Based on thresholds (e.g., configured by the network administrator), the network power administration system 102 can automatically remove power from outlets 120 as load shedding conditions occur, for example. If the outlet is supplying power to a server of some type (e.g., 122 or 124), the network power administration system 102 signals a remote shutdown agent (not shown) that can be running on the server to perform an orderly system shutdown. This communication can take place via the TCP/IP network 111 Outlets supplying power to devices that do not have network capabilities can still be powered off for load shedding. The drawing depicts both types of devices (e.g., those with TCP/IP capabilities and those without).

The network power administration system 102 is a multidimensional system tool that can communicate with a wide variety of sensors and power equipment to monitor the physical environment and then use that information to intelligently shut down equipment and servers. When shutting down servers, the network power administration system 102 can communicate with a wide range of operating systems to cause an orderly system shutdown prior to removing power from the server. An optional remote shutdown module software package can provide the network interface for the network power administration system 102 when shutting down servers.

In some embodiments, the network power administration system 102 can automatically load shed or power down an outlet when limits are exceeded for certain operating factors, such as, for example, the temperature as monitored by the network power administration system environmental monitoring equipment, the load as measured by the network power administration system infeed devices, and the external power availability of a UPS device that is supplying power to the network power administration system.

In some embodiments, each among a series of subsets of predetermined outlets may be powered down over a period of time. In some embodiments, this load shedding capability can terminate when and if one or more conditions warrant such termination.

In some embodiments, the disclosed technology can first check a supported device to verify that the device is the desired device before terminating the power supplied to the device.

Outlets automatically powered off by this feature can, if desired, be set to automatically power back on when the condition returns to normal. In some embodiments, this reverse operation may commence when the power supply (e.g., reserve power supply) resumes the ability to provide power from an outside source (e.g., a power input to the power supply). An auto-recover feature (e.g., that can be enabled or disabled for each load shedding event) can control whether outlets that have been powered off by load shedding will be automatically powered back on when the condition returns to normal.

In some embodiments, the network power administration system 102 can provide an integrated power control tool that provides automatic power management over a wide range of applications. The network power administration system 102 can have the capability of monitoring multiple different UPS devices to ensure that power is available and, when power interruptions occur, the network power administration system 102 can automatically conserve the remaining power by load shedding one or more devices.

In some embodiments, the network power administration system 102 can signal a remote shutdown agent on the server to cause an orderly shutdown of the system before power is removed if the device that is to be load shed happens to be a server of some type. This capability can exist for multiple different operating systems including Windows, Linux, HP-UX, Solaris, AIX and Netware. The remote shutdown agent can be incorporated as a component of the disclosed load shedding technology.

In some embodiments, a power distribution unit, power supply, or both, can be connected to a remote system through a communications network and, using the communications network, exchange power monitoring information and/or power controlling information. In some embodiments, a wireless network can be used for communication. For example, communication between a UPS and a PDU can take place through a wireless network. Communication with a remote administration system can also take place through a wireless network.

In some embodiments, a power distribution device (e.g., a PDU) and a power supply (e.g., a UPS) may be integrated.

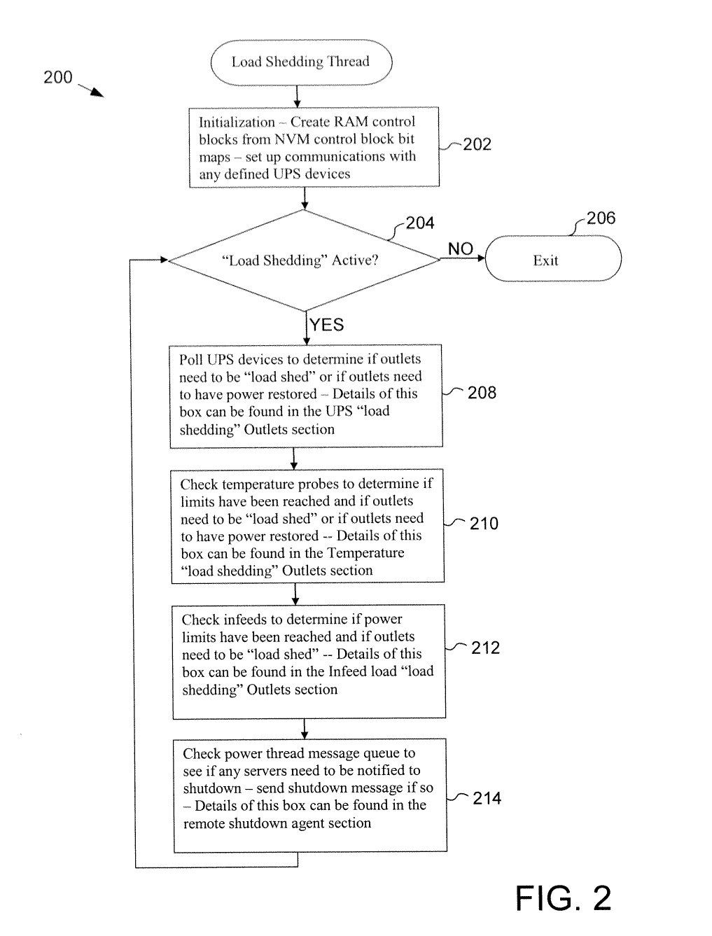

FIG. 2 is a flowchart of the general logic of a load shedding thread for the system of FIG. 1.

An initialization 202 takes place that includes, in the example, creating RAM control blocks from NVM control block bit maps and setting up communications with any defined power supply (e.g., UPS) devices.

A query 204 takes place to determine whether load shedding is active. If not, the logic exits at 206. If load shedding is active, however, the logic continues at 2)8.

Power supply (erg, UPS) devices are polled 208 to determine whether outlets need to be load shed or if outlets need to have power restored.

Temperature probes are checked 210I to determine whether limits have been reached and if outlets need to be load shed or if outlets need to have power restored.

Infeeds are checked 212 to determine whether power limits have been reached and if outlets need to be load shed.

A power thread message queue is checked 214 to determine whether any servers need to be notified to shutdown, If so, a shutdown message can be sent. The logic then returns to 204.

### Load Shedding Outlets

Outlets can be powered off automatically when the disclosed load shedding firmware determines that one or more of the power supply (e.g., UPS) devices that are supplying power to the infeed that is associated with the outlet has lost external power. That is, the UPS is now on battery power.

Load shedding operations can occur when the load shedding firmware is in communications with the power supply (e.g., UPS).

The firmware can regularly poll, for example, the power supply devices looking for the external power state of the devices. A flag associated with the device IP address can be used to determine the type of device so that the appropriate SNMP OID can be used for the polling operation. The mechanism used for polling the devices can be SNMP, for example.

When an auto-recovery feature is enabled for load shedding, outlets powered off when the power supply loses external power can be flagged to indicate that they should have power restored when the power supply regains external power. To prevent conditions where the outlets are powered off and on based on a very short power interruption, the firmware will desirably not begin load shedding until the power supply has returned indications that external power is either lost or restored for two consecutive polling loops. The power supply device polling loop interval can be 10 seconds between poll operations, for example

If an outlet is already powered off when an external power failure occurs, no action is generally required by the firmware and the firmware may, if desired, not restore power to such an outlet when the power supply regains external power.

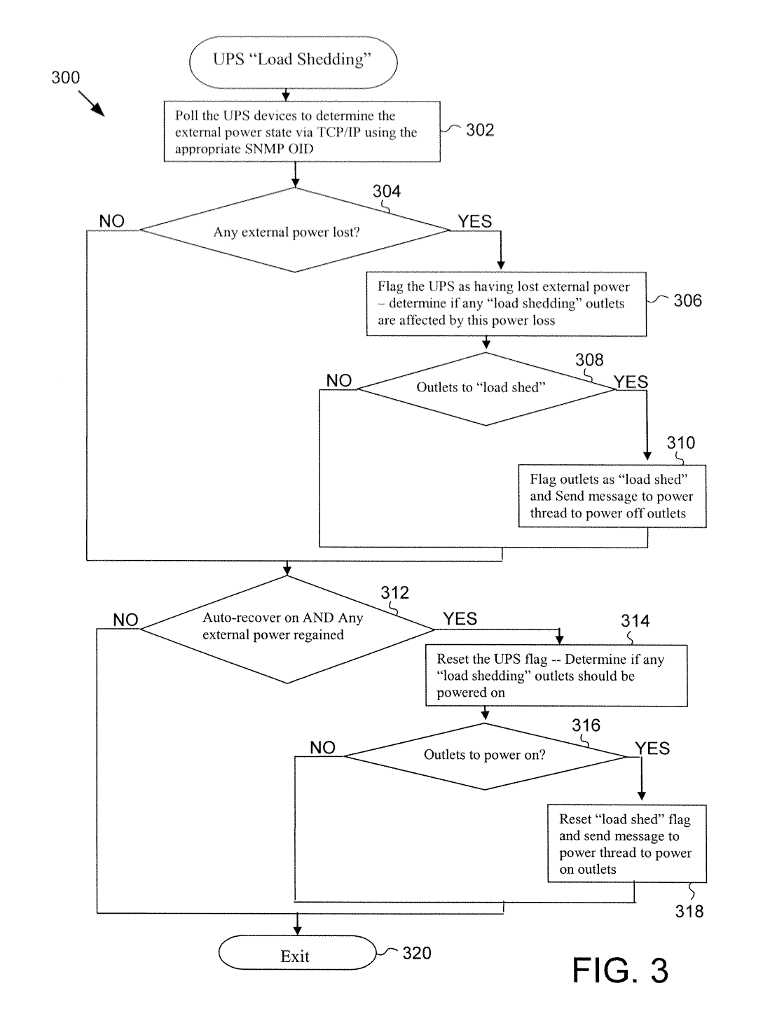

FIG. 3 is a flowchart of the logic of a sample load shedding operation for the system of FIG. 1.

Power supply (e.g., UPS) devices are polled 302 to determine the external power state (e.g., via TCP/IP using the appropriate SNMP OID).

A query 304 takes place to determine whether any external power has been lost. If so, the logic proceeds to 306. If not, the logic proceeds to 312.

The power supply is flagged 306 as having lost external power. Also, a determination is made as to whether any load shedding outlets are affected by this power loss. The logic then proceeds to 308.

A determination 308 is made as to whether outlets are to be load shed. If so, the logic proceeds to 310. If not, the logic proceeds to 312.

The applicable outlets are flagged 310 as load shed and a message is sent to the power thread to power off the outlets. The logic proceeds to 312.

A query 312 determines whether the auto-recover is on and whether any external power has been regained. If so, the logic proceeds to 314. Otherwise, the logic exits at 320.

The power supply flag is reset 314 and a determination is made as to whether any load shedding outlets should be powered on. The logic proceeds to 316.

A query 316 determines whether outlets are to be powered on. If so, the logic proceeds to 318. Otherwise, the logic exits at 320.

The load shed flag is reset 318 and a message is sent to the power thread to power on the outlets. The logic then exits at 320.

### Environmentally Controlled Outlets

The disclosed technology can provide the ability to specify whether an outlet is to be environmentally controlled. An outlet that is environmentally controlled can be powered off or on automatically based on temperature, infeed load, or power supply power status, for example. Other environmental conditions that can be monitored include, for example, humidity, smoke, or water. An individual outlet can be controlled by any one of these three factors, for example, and more than one environmental factor can be monitored for a single outlet.

If any of the environmental factors reaches a limit that may cause the outlet to be powered off, it can be powered off. Outlets associated with events that have an auto-recover feature enabled can have power restored when environmental factors reach a condition consistent with restoring power to the outlet. When this auto-recover feature is enabled, the environmental monitoring feature can set a flag for outlets that it has powered off and it may restore power to outlets that the environmental monitoring feature previously powered off, for example. This flag is desirably not set when the auto-recover feature is not enabled for a particular event. Some events can have the auto-recover feature enabled while others can have the auto-recover feature disabled. This flag can prevent the environmental monitoring feature from restoring power to outlets that did not have power when the environmental condition first occurred or for events that do not have the auto-recover feature enabled.

Manual control of outlets is generally not affected by environmental factors. Environmentally controlled outlets usually change state only when an environmental condition changes that will affect the state of the outlet based on the environmental parameters for that outlet. Environmentally controlled outlets, if desired, are not regularly polled to ensure they are in an expected state based on environmental factors.

In order for an outlet to come under environmental control it may, if desired, be configured by the administrator and it must be set to a power on state. This is because the environmental monitoring feature will generally only restore power to outlets that were previously powered off by the environmental monitoring feature.

When a power supply (e.g., UPS) has an associated IP address, the environmental monitoring firmware can regularly poll, for example, the power supply to determine if external power is available to the power supply. If the environmental monitoring firmware determines the power supply has lost external power, automatic load shedding can occur for outlets so configured for the infeeds associated with the power supply. When the firmware determines that external power is restored, the firmware desirably restores power to outlets that were previously powered off for load shedding. If more than one power supply is supplying power to a single infeed, all power supply devices generally have external power before the firmware will restore power to previously load shed outlets.

### Temperature Load Shedding Outlets

Outlets can be configured to be powered off automatically when an SNMP temperature high value is exceeded. When a condition occurs that would cause an SNMP temperature high trap to occur (e.g., if an SNMP trap was enabled), the network power administration system firmware can load shed all outlets associated with the temperature probe. When the temperature high trap condition is cleared, the network power administration system firmware can restore power to all outlets that were previously load shed by the firmware if the auto-recovery feature is enabled for the associated temperature probe. As with UPS load shedding outlets, power may not be restored to outlets that were already in a power off state and therefore were not load shed by the firmware.

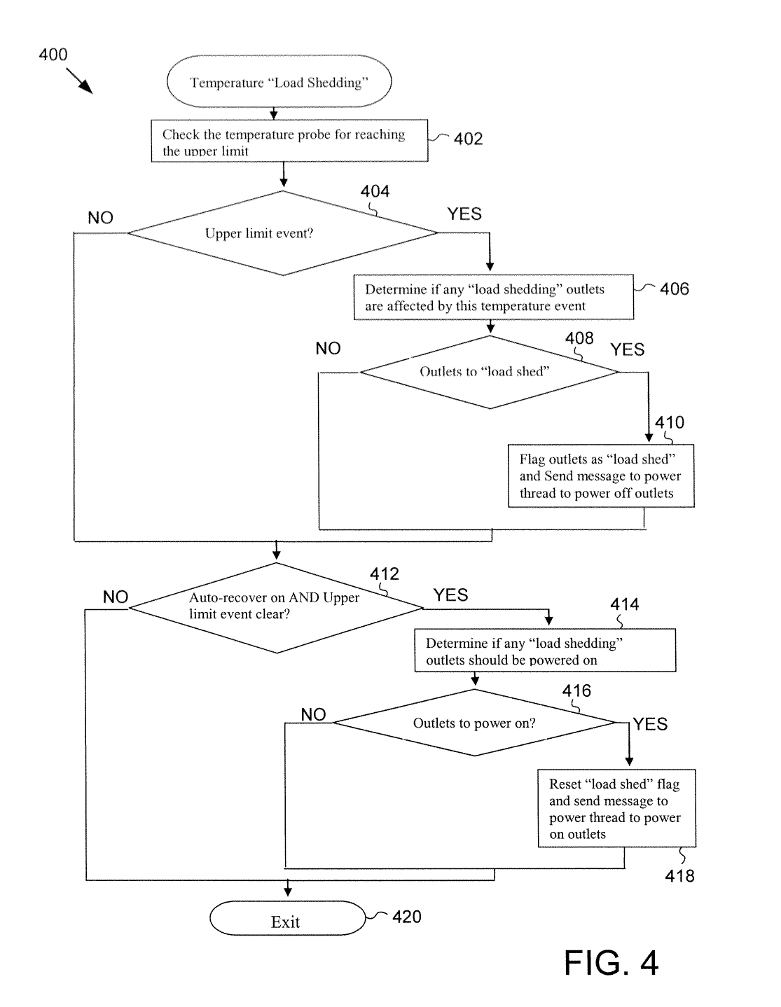

FIG. 4 is a flowchart of the logic of a sample temperature load shedding operation for the system of FIG. 1.

The temperature probe is checked 402 to determine whether it has reached the upper limit.

A query 404 takes place to determine whether an upper limit event exists. If so, the logic proceeds to 406. If not, the logic proceeds to 412.

A determination 406 is made as to whether any load shedding outlets are affected by the temperature event. The logic then proceeds to 408.

A determination 408 is made as to whether outlets are to be load shed. If so, the logic proceeds to 410. If not, the logic proceeds to 412.

The applicable outlets are flagged 410 as load shed and a message is sent to the power thread to power off the outlets. The logic proceeds to 412.

A query 412 determines whether the auto-recover is on and whether the upper limit event has cleared. If so, the logic proceeds to 414. Otherwise, the logic exits at 420.

A determination 414 is made as to whether any load shedding outlets should he powered on. The logic proceeds to 416.

A query 416 determines whether outlets are to be powered on. If so, the logic proceeds to 418. Otherwise, the logic exits at 420.

The load shed flag is reset 418 and a message is sent to the power thread to power on the outlets. The logic then exits at 420.

### Infeed Load Load Shedding Outlets

Outlets can be configured to be powered off when a load high SNMP trap threshold is reached for an infeed that is providing power to the outlet. This condition would typically generate an SNMP trap if SNMP was active and the trap was enabled.

Although auto-recovery of infeed load load shed outlets can cause an on/off thrashing problem, it is possible to enable the auto-recovery feature for infeed load load shedding events. The firmware will desirably restore power to all outlets that were previously load shed by the firmware if the auto-recovery feature is enabled for the associated infeed. As with UPS load shedding outlets, power will desirably not be restored to outlets that were already in a power off state and therefore were not load shed by the firmware. If on/off thrashing occurs on an outlet, the REBOOT time delay will desirably ensure the thrashing has at least a short time delay between cycles.

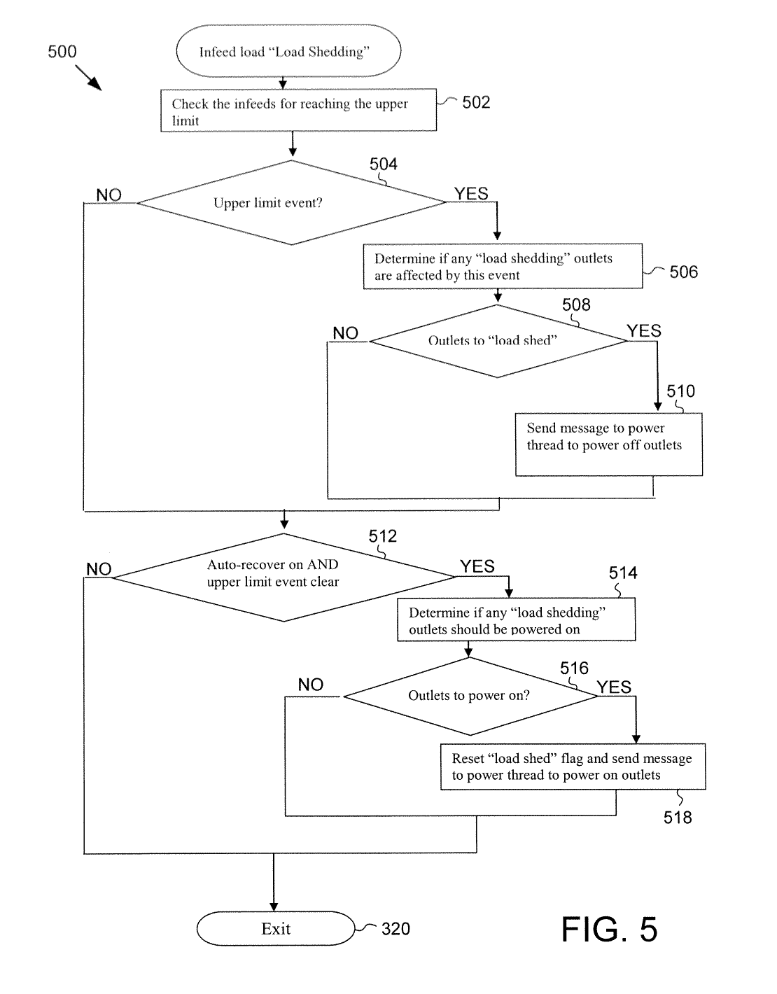

FIG. 5 is a flowchart of the logic of a sample infeed load load shedding operation for the system of FIG. 1.

The infeeds are checked 502 to determine whether the upper limit has been reached.

A query 504 takes place to determine whether an upper limit event exists, If so the logic proceeds to 516. If not, the logic proceeds to 512.

A determination 506 is made as to whether any load shedding outlets are affected by the event. The logic then proceeds to 508.

A determination 508 is made as to whether outlets are to be load shed. If so, the logic proceeds to 510. If not, the logic proceeds to 512.

A message is sent 510 to the power thread to power off the outlets. The logic proceeds to 512.

A query 512 determines whether the auto-recover is on and whether the upper limit event has cleared. If so, the logic proceeds to 514. Otherwise, the logic exits at 520.

A determination 514 is made as to whether any load shedding outlets should be powered on. The logic proceeds to 516.

A query 516 determines whether outlets are to be powered on. If so, the logic proceeds to 518. Otherwise, the logic exits at 520.

The load shed flag is reset 518 and a message is sent to the power thread to power on the outlets. The logic then exits at 520.

### Remote Shutdown Agent

A software package that can run on various server systems can run as a system service and use a TCP/IP network to monitor shutdown requests from the network power administration system firmware. The remote shutdown agent can have the ability to execute user scripts prior to actually shutting a server down. The server shutdown can be accomplished using the operating system interfaces for orderly shutdown.

The remote shutdown agent is typically not required for operation of the network power administration system load shedding enhancement. It is generally an additional option provided in support of the disclosed load shedding operations. Note that the remote shutdown of servers generally occurs for all power off operations on an outlet, not just for load shedding operations. Manual power off commands initiated by a system, user desirably cause the remote shutdown if the associated outlet is configured for this feature.

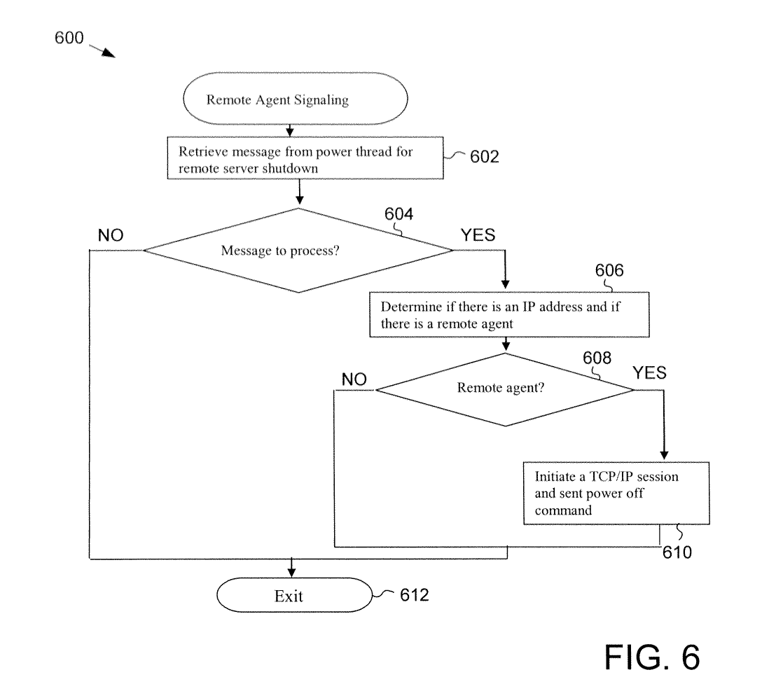

FIG. 6 is a flowchart of the logic of a load shedding thread used to signal a remote shutdown agent for the system of FIG. 1.

A message is retrieved 602 from the power thread for a remote server shutdown. The logic proceeds to 604.

A query 604 takes place to determine whether there is a message to process. If so, the logic proceeds to 606. If not, the logic exits at 612.

A determination 606 is made as to whether there is an IP address and if there is a remote agent. In some embodiments, an outlet maintains an IP address corresponding to a device powered by the outlet. A flag can be used in association with the IP address to indicate the type of device being powered by the outlet. The IP address may be used for several purposes. For example, it can be used to verify that the device to be powered down is the particular device desired to be powered down. Using the IP address, an indication can be sent to a device (e.g., a server) that power is going to be removed from the device and that the device should therefore perform an orderly shutdown before the power is removed. The logic then proceeds to 608.

A determination 608 is made as to whether there is a remote agent. If so, the logic proceeds to 610. If not, the logic exits at 612.

A TCP/IP session is initiated 610 and a power off command is sent. The logic then exits at 612.

### An Embodiment of the Disclosed Technology

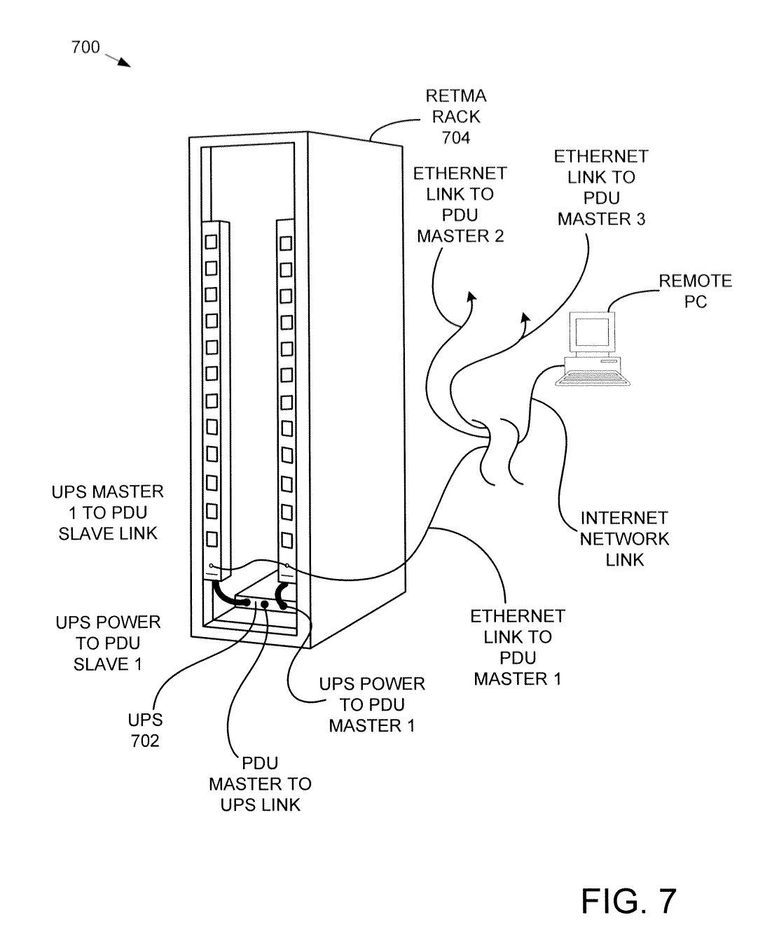

FIG. 7 is a three-dimensional view of an embodiment 700 of the disclosed technology utilizing one or more PDUs (not shown) powered by a separate UPS 702 mounted in a RETMA rack 704. The UPS 702 has the ability to provide at least one of the PDUs (e.g., a master PDU with a slave PDU attached) with indications of the state of the UPS 702. This state information can include an indication of the state of the external power to the UPS 702. This data allows the master PDU firmware to determine when load shedding should be commenced and when it should end. Further, the UPS 702 may have the capability to provide the master PDU firmware with an indication of the state of the UPS batteries and load shedding can be managed accordingly. A slave PDU may provide backup functionality for the master PDU firmware. The use of master and slave PDUs is described, for example, in U.S. patent application Ser. No. 11/459,011, filed Jul. 20, 2005, the contents of which are hereby incorporated herein by reference.

As is well known in the art, software could be used in the place of firmware. In addition, software functionality provided by the firmware can instead be provided remote from the master PDU, in a remote network management system running on remote computing device in network communication with the master PDU, for example. In other embodiments, a master UPS can be linked to the remote network management system and receive and forward commands to the slave PDU.

In the illustrated embodiment, the master PDU firmware supports network communications with UPS devices. For example, UPS devices can be equipped with a Network Management Card (NMC). An NMC generally refers to a UPS embedded agent that provides access to a series of XML pages that can be accessed by the PDU firmware using HTTP GET requests.

A PDU device, such as a master or other PDU, with the disclosed load shedding feature can continuously poll the UPS device that is providing power to the PDU device. If the external power to the UPS is interrupted, the PDU can automatically shut power off for non-critical devices to conserve the UPS batteries. When the external power is restored to the UPS, the PDU restores power to the devices that were previously shut down. Alarms, such as SNMP traps, can be generated when these actions occur.

In some embodiments, the disclosed technology can monitor multiple power supplies (e.g., UPSes) to ensure that power remains available and that, when power interruptions occur, remaining power is reserved or conserved by automatically performing load shedding operations with respect to one or more predetermined devices.

One of skill in the art will appreciate that there are many variations to how any given number of power supplies (e.g., UPSes) and power distribution devices (e.g., PDUs) can be arranged. For example, in some embodiments, a single housing (e.g, a box) can be built in which both a UPS and a PDU can be mounted. Such housings, as well as racks, can he built having a variety of form factors (e.g., horizontal and/or vertical form factors). One or more such housings can he mounted in various locations in or supporting an associated electrical equipment rack. In some embodiments, a UPS can be outside of a rack (e.g., mounted on the outer housing of a rack or located distal from the rack). Similarly, one or more PDUs can he located external to a rack.

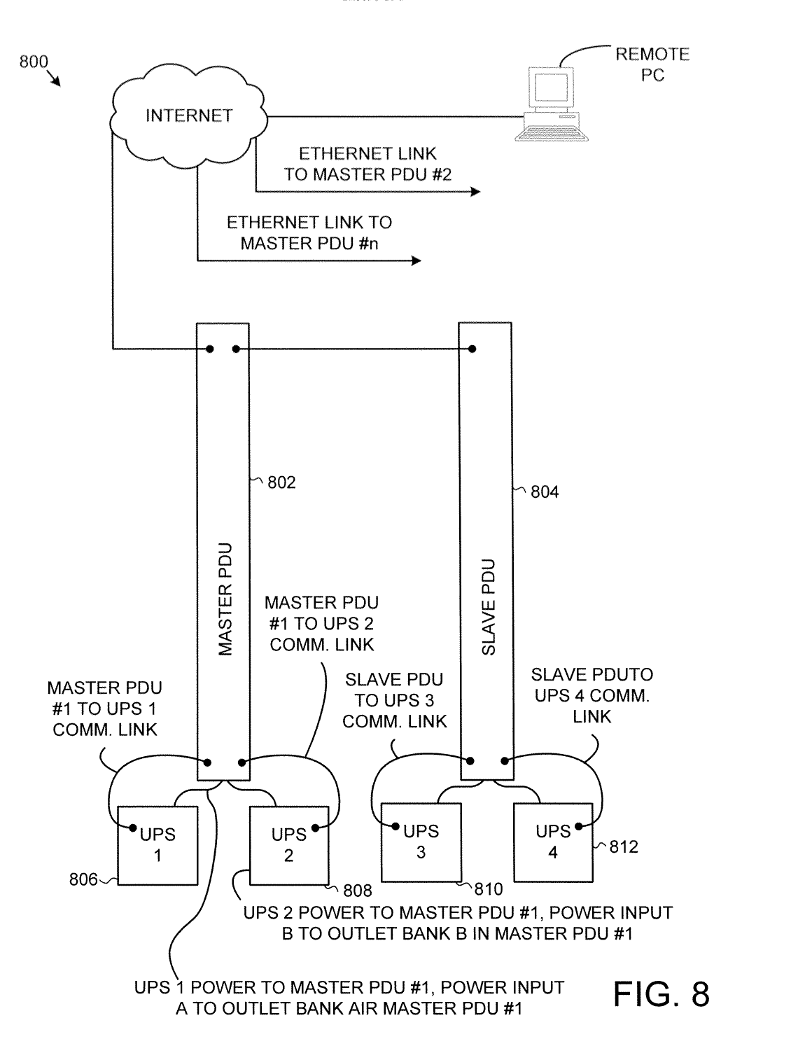

In some embodiments, one or more power supplies (e.g., reserve power supplies) can he implemented in conjunction with one or more separate power distribution devices or housings. A power supply may have a vertical or horizontal form factor and, depending on the form factor, may be mounted in various locations in or to support a given electrical equipment rack or other arrangement of associated electrical devices (e.g., appliances). For example, the embodiment illustrated by FIG. 8 has a power supply (UPS 702) that is horizontally mounted inside a RETMA rack and also has two power distribution devices (a master PDU and a slave PDU) that are both vertically mounted inside the rack. In some embodiments, all power supplies and power distribution devices are mounted horizontally inside a single housing (e.g., a rack). In some embodiments, all such power devices are mounted vertically inside a single housing. Various alternative embodiments involve different combinations of power supplies and power distribution units being mounted vertically and/or horizontally inside, external to, and/or distal from one or more housings.

FIG. 8 is a schematic view of an alternative embodiment 800 of the disclosed technology in which a master PDU 802 or a slave PDU 804 can have one power input supplying power to one set or bank of outlets in the master PDU 802 or slave PDU 804, as applicable, and another power input supplying power to another set of outlets in the master PDU or slave PDU, as applicable. Each such power input can in turn be supplied power by a separate or, if desired, dedicated UPS (e.g., 806-812) for such power input, and each such UPS can communicate with the applicable master PDU over a communications network to have the master PDU) 802 accomplish load shedding when needed for a given UPS and its associated power outlets. In turn, the master PDU 802 may be accessed either over the network, or by direct connection to the associated PDU, in order to provide remote control or monitoring of the master PDU 802, an associated slave PDU 804 if any, and all UPSs associated with the master PDU 802 and slave PDU 804.

Existing tower hardware and software can be used in a power supply board, relay-outlet boards, and peripheral/display boards, for example. The resulting PDU may, in some embodiments, consist of a 4-, 8-, or 16-outlet power tower that can be accessed out-of-band via an RJ45 serial port or a DB9 serial port, or in-band over a 10/100Base-T Ethernet connection by Telnet, SSH, or an HTML browser. Optionally, an RJ12 port on the tower can be connected to a second 4-, 8-, or 16-outlet power tower that is almost entirely a slave to the first tower, in that it can only be controlled by/via the first/master tower. The master and slave power tower may be mounted on one or two vertical electronic equipment racks, such as RETMA racks. The associated PDU supplying power to the master and slave may be mounted in one of these or another rack.

For the master tower, personality module hardware and software can provide all of the control and user interface. Personality modules are described, for example, in U.S. patent application Ser. No. 10/313,314, filed Dec. 6, 2002, the contents of which are hereby incorporated herein by reference. On the slave tower, a slave tower personality module can bridge the external and internal I2C buses, allowing the master to control the slave tower the same as the master tower, with no software or microprocessor needed on the slave tower personality module. The slave tower personality module can also act as a backup master for load-display and power-up sequencing.

The personality module can support an HTML interface (e.g., Ethernet) and a command-line interface (e.g., Telnet, SSH, and Serial). In some embodiments, up to 128 users may access the master tower personality module. One administrative user (ADMN) can exist by default, and the ADMN user can default to having access to all outlets. The personality module can also support power outlet grouping, with up to 64 groups of outlets, for example.

One of skill in the art will appreciate that the disclosed technology is not limited to a rack-mounted environment. For example, the disclosed technology could be implemented as part of a power management system providing power to other environments, such as to a house, an office, or a manufacturing plant, for example.

### Auto-Recover Feature

An auto-recover feature can allow a load shedding facility the ability to restore power to outlets that have been load shed when the event or events that caused the load shed return to normal. By default, UPS external power lost events generally have the auto-recover feature enabled. Temperature and infeed load events can have the auto-recover feature disabled by default since temperature and infeed load events could cause an outlet to go into a thrashing state where the outlet is continually powered off then on by the load shedding facility. Infeed load event load shed outlets are especially vulnerable to this thrashing behavior. Temperature event load shed outlets are usually less vulnerable, but the thrashing could still occur although it would be slower than infeed load event thrashing.

Outlets that have been powered off by load shedding will generally be restored to power if the event that caused the load shed had the auto-recover feature enabled when the event occurred. Enabling or disabling the auto-recover feature generally does not affect outlets currently in a power off state due to load shedding. To prevent an outlet from recovering after the outlet has been load shed with the auto-recover feature enabled, an administrator can disable environmental control of the outlet.

Outlets that have been load shed based on an event that has the auto-recover feature enabled are generally powered on after all events associated with the outlet have returned to the normal state.

To illustrate this one can consider the following example. An outlet is load shed by a UPS external power lost event. This event has an auto-recover feature enabled so the outlet is marked for recovery. The outlet is also controlled by temperature probe1, but this event does not have the auto recover feature enabled. While the outlet is still powered off because of the load shed event, the temperature limit is exceeded causing a temperature event. Following this event, the UPS recovers external power which clears the U)PS external power last event. Although the outlet is flagged for recovery, it is not powered on at this time. Later, when the temperature probe1 limit event is cleared (e.g., the temperature falls below the limit) the outlet will be powered on. This occurs even though the event that just cleared is not an auto-recovery event because the event that caused the load shed was an auto-recover event. The inverse of this example would be if the outlet was load shed due to a temperature probe I event. If the UPS external power lost event occurs while the outlet is powered off because of the temperature probe1 event, the outlet will not be flagged to recover and it will not be powered on even when all of the load shed events clear.

All outlets eligible for auto-recovery are generally powered on after they have been off for at least the existing system REBOOT delay time. This prevents outlets from being powered on immediately after being powered off. For example, if an outlet is being load shed and the outlet is associated with a server that has a remote shutdown agent, it is possible that the event that caused the load shed will clear while the shutdown delay is in progress. Because the server is being powered off by the remote shutdown agent, it is desirable that the outlet actually be powered off because if it is not the server will be off and it will usually not recover. Therefore, the load shed occurs even though the event that caused the load shed clears before the actual outlet power off occurs. Because the auto-recovery feature can cause the outlet to be powered on, the REBOOT delay time can be used to prevent an immediate on/off/on transition for the outlet. This safeguard can be implemented in the power control thread.

### Outlet On/Off Delay Times

When load shedding conditions occur, an orderly shutdown of servers powered by network power administration system outlets may be required. In general, server computers desirably should be shutdown in an orderly manner to prevent data and application corruption,

A control block structure can include a field in the outlet control block that is a shutdown delay timer value and a second field that can be the script delay timer value. The sum of these two time values is generally the amount of time (e,-g, in seconds) the firmware will delay after sending a shutdown command to a server before actually removing power from an outlet. This time interval is desirably designed to allow the server shutdown software enough time to perform an orderly shutdown of the server. The outlet can be set in a “pending power off” state until the time expires and it is then powered off.

When the power control task recognizes an outlet with a configured shutdown/script delay timer, it can signal the load shedding task that a shutdown delay is in progress. The load shedding task desirably determines if a remote shutdown agent is available for the system associated with the outlet and if so, it signals the server to begin a shutdown. The server can be notified via the shutdown signal of the amount of time the agent should allow for any shutdown scripts to run prior to beginning the actual system shutdown.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. A method of power administration, comprising:
using a power supply, providing power through a power input to a power distribution system, wherein the power distribution system comprises a plurality of power outlets, wherein each of the plurality of power outlets is connectable to an electrical device;
monitoring at least one of the following: the power supply, power provided to or by the power distribution system, information regarding the power to the power supply, and information regarding the power supply or its status;
based on the monitoring, determining whether at least one predetermined condition is met;
if the at least one predetermined condition is met, turning off the operating power of less than all of plurality of power outlets in the power distribution system.

2. The method of claim 1 wherein the turning off step further comprises powering down at differing times each among a plurality of subsets of predetermined outlets among the plurality of power outlets.

3. The method of claim 1, further comprising: if another of the predetermined conditions is met, ceasing the turning off of operating power of at least one of the plurality of power outlets.

4. The method of claim 1, further comprising: if the at least one of the plurality of predetermined conditions returns to an initial state, turning on the operating power of at least one of the plurality of power outlets that had been turned off.

5. The method of claim 1, wherein the at least one of the plurality of predetermined conditions is met when the power provided through the power input experiences a power interruption.

6. The method of claim 5, further comprising if the power interruption ceases? turning on the operating power of the at least one of the plurality of power outlets.

7. The method of claim 1, further comprising: using a communications network, connecting the power distribution system to a remote system.

8. The method of claim 7, further comprising exchanging power monitoring information between the power distribution system and the remote system.

9. The method of claim 7, further comprising exchanging power controlling information between the power distribution system and the remote system.

10. The method of claim 7, further comprising: using the communications network, connecting the power supply to the remote system.

11. The method of claim 1, further comprising: using a remote shutdown agent on an attached electrical device, causing an orderly shutdown of the attached electrical device.

12. The method of claim 1, further comprising determining whether at least one of the plurality of power outlets to be turned off supplies power to a server and, based on the determining, invoking a remote shutdown agent to shut down the server.

13. The method of claim 1, further comprising setting a flag for at least one of the plurality of power outlets to be turned off.

14. The method of claim 1, further comprising configuring and setting to a power-on state at least one of the plurality of power outlets within the power distribution system.

15. The method of claim 4, further comprising preventing at least another of the plurality of power outlets that had been turned off from being turned on if the at least another of the plurality of outlets did not have power when the less than all of the plurality of power outlets had been turned off.

16. A method of load shedding, comprising:
in a power administration system, polling at least one of a plurality of power supply devices to determine whether at least one of a plurality of power outlets needs to be load shed; and
polling at least one of a plurality of power supply devices to determine whether at least one of the plurality of power outlets needs to have power restored.

17. The method of claim 16, further comprising checking at least one temperature probe to determine whether at least one limit has been reached and, based on the checking at least one temperature probe, determining whether at least one of the plurality of power outlets needs to be load shed and determining whether at least one of the plurality of power outlets needs to have power restored.

18. The method of claim 16, further comprising checking at least one infeed to determine whether at least one power limit has been reached and, based on the checking at least one infeed, determining whether at least one of the plurality of power outlets needs to be load shed and determining whether at least one of the plurality of power outlets needs to have power restored.

19. The method of claim 16, further comprising invoking a remote shutdown agent, wherein the invoking comprises:
retrieving a shutdown message;
determining whether the shutdown message is to be processed,
based on the determining whether the shutdown message is to be processed, determining whether there is an IP address and determining whether there is a remote agent; and
based on the determining whether the shutdown message is to be processed and the determining whether there is an IP address and whether there is a remote agent, initiating a TCP/IP session and transmitting a power off command to the remote agent using the IP address.

20. A power administration system, comprising
a power supply in power supply communication with a power distribution system, wherein the power distribution system comprises a power input and a plurality of power outputs, wherein each of the plurality of power outputs is connectable to one of a plurality of electrical devices; and
a power supply monitoring system in power supply monitoring communication with the power supply, the power supply monitoring system in load shedding communication with the plurality of power outputs.

21. The power administration system of claim 20, wherein the power supply comprises an uninterruptible power supply (UPS).

22. The power administration system of claim 20, wherein the power distribution system comprises a power distribution unit (PDU).

23. The power administration system of claim 20, further comprising a housing in which the plurality of power outputs are mounted.

24. The power administration system of claim 23, wherein the housing has a vertical form factor.

25. The power administration system of claim 23? w herein the housing has a horizontal form factor.

26. The power administration system of claim 20, further comprising a remote shutdown agent operable to provide an orderly shutdown of at least one of the plurality of electrical devices.
